(19) United States
(12) Patent Application Publication
(10) Pub. No.: US 2022/0101328 A1
(43) Pub. Date: Mar. 31, 2022

(54) SYSTEMS, METHODS, AND DEVICES FOR ASSIGNING A TRANSACTION RISK SCORE

(71) Applicant: JPMORGAN CHASE BANK, N.A., New York, NY (US)

(72) Inventors: Ralph DARMO, West Chester, PA (US); Jeremiah C. OLVER, Middletown, DE (US); Tuan DAO, Richardson, TX (US); Howard SPECTOR, Woolwich, NJ (US); Scott H. OUELLETTE, Kingston, NH (US); Craig M. MULLANEY, Newark, DE (US); Donna BEATTY, New York, NY (US)

(21) Appl. No.: 17/487,808

(22) Filed: Sep. 28, 2021

Related U.S. Application Data
(60) Provisional application No. 63/085,010, filed on Sep. 29, 2020.

(51) Int. Cl. G06Q 20/40; G06Q 40/02

(52) U.S. Cl. CPC G06Q 20/4016; G06Q 20/4014; G06Q 20/4015; G06Q 40/02

(57) ABSTRACT

Systems, methods, and devices for assigning a transaction risk score are disclosed. According to one embodiment, a method for generating a transaction risk score may include: (1) receiving, by a transaction scoring service computer program and from an electronic device, a merchant URL that is being accessed by an application or a browser executed on the electronic device; (2) retrieving, by the transaction scoring service computer program, a plurality of transactions involving the merchant URL; (3) generating, by the transaction scoring service computer program, a risk score for the merchant URL based on the plurality of transactions; (4) generating, by the transaction scoring service computer program, a warning in response to the risk score exceeding a predetermined threshold; and (5) communicating, by the transaction scoring service computer program, the warning to the application or the browser.

### RELATED APPLICATIONS

This application claims priority to, and the benefit of, U.S. Provisional Patent Application Ser. No. 63/085,010 filed Sep. 29, 2020, the disclosure of which is hereby incorporated, by reference, in its entirety.

### BACKGROUND OF THE INVENTION

### 1. Field of the Invention

Embodiments are generally directed to systems, methods, and devices for assigning a transaction risk score.

### 2. Description of the Related Art

Online transactions pose a certain amount of risk to the consumer, the merchant, and the financial institution that issued the payment instrument, such as a credit card, that is being used to conduct the transaction. By providing transaction details to an unscrupulous merchant or individual, the consumer may put the consumer's payment card information at risk. A merchant may ship merchandise to a fraudster that may have stolen someone else's payment card information and may be liable for any chargeback. And, the issuing financial institution may have to devote resources to investigating any dispute and, depending on the type of transaction, may also bear some responsibility for the transaction. If the financial institution has to reissue the financial instrument, the financial institution will also have to bear this expense.

### SUMMARY OF THE INVENTION

Systems, methods, and devices for assigning a transaction risk score are disclosed. According to one embodiment, a method for generating a transaction risk score may include: (1) receiving, by a transaction scoring service computer program and from an electronic device, a merchant URL that is being accessed by an application or a browser executed on the electronic device; (2) retrieving, by the transaction scoring service computer program, a plurality of transactions involving the merchant URL; (3) generating, by the transaction scoring service computer program, a risk score for the merchant URL based on the plurality of transactions; (4) generating, by the transaction scoring service computer program, a warning in response to the risk score exceeding a predetermined threshold; and (5) communicating, by the transaction scoring service computer program, the warning to the application or the browser.

In one embodiment, the transaction scoring service computer program may include an inline appliance in a network comprising the electronic device, the transaction scoring service computer program, and a merchant backend hosting the merchant URL.

In one embodiment, the electronic device may include a computer, a smart phone, or an Internet of Things appliance.

In one embodiment, the plurality of transactions involving the merchant URL may be received from a financial institution.

In one embodiment, the plurality of transactions involving the merchant URL are classified as fraudulent transactions, non-fraudulent transactions, or disputed tractions.

In one embodiment, the method may further include retrieving, by the transaction scoring service computer program, network activity data for the merchant URL. The transaction scoring service computer program may further generate the risk score for the merchant URL based on the network activity data.

In one embodiment, the method may further include retrieving, by the transaction scoring service computer program, data breach data the merchant URL. The transaction scoring service computer program may further generate the risk score for the merchant URL based on the data breach data.

According to another embodiment, a method for generating a transaction risk score may include: (1) receiving, by a transaction scoring service computer program and from a merchant backend, an identification of an electronic device executing an application or a browser and accessing a merchant URL; (2) retrieving, by the transaction scoring service computer program, a plurality of transactions involving the electronic device; (3) generating, by the transaction scoring service computer program, a risk score for the electronic device based on the plurality of transactions; (4) generating, by the transaction scoring service computer program, a warning in response to the risk score exceeding a predetermined threshold; and (5) communicating, by the transaction scoring service computer program, the warning to the merchant backend.

In one embodiment, the transaction scoring service computer program may include an inline appliance in a network comprising the electronic device, the transaction scoring service computer program, and the merchant backend.

In one embodiment, the electronic device may include a computer, a smart phone, or an Internet of Things appliance.

In one embodiment, the plurality of transactions involving the electronic device are received from a financial institution.

In one embodiment, the plurality of transactions involving the electronic device are classified as fraudulent transactions, non-fraudulent transactions, or disputed tractions.

In one embodiment, the method may further include determining, by the transaction scoring service computer program, a confidence level in the identification of the electronic device. The risk score for the electronic device may be further based on the confidence level.

In one embodiment, the method may further include retrieving, by the transaction scoring service computer program, network activity data for the electronic device. The transaction scoring service program may further generate the risk score for the electronic device based on the network activity data.

According to another embodiment, a method for generating a transaction risk score may include: (1) receiving, by a transaction scoring service computer program and from a merchant backend, transaction risk configuration data that identifies risky transactions for transactions conducted at the merchant backend; (2) receiving, by the transaction scoring service computer program and from the merchant backend, transaction information comprising electronic device transaction information for an electronic device conducting a transaction at a merchant URL and/or customer information a customer conducting the transaction at the merchant URL; (3) retrieving, by the transaction scoring service computer program, a customer profile associated with the electronic device and/or the customer information; (4) generating, by the transaction scoring service computer program, a transaction risk for the electronic device based on the customer profile and the customer profile; (5) determining, by the transaction scoring service computer program and based on a comparison of the transaction risk and the transaction risk configuration data, that the transaction is a risky transaction; (6) generating, by the transaction scoring service computer program, a warning for the risky transaction; and (7) communicating, by the transaction scoring service computer program, the warning to the merchant backend.

In one embodiment, the transaction risk configuration data may identify a location-based risk, and the customer profile identifies a registered customer location, and the transaction is determined to be a risky transaction in response to the registered customer location differing from a transaction location.

In one embodiment, the transaction risk configuration data may identify a location restriction, and the transaction information may include a transaction location for the transaction, and the transaction may be determined to be a risky transaction in response to the transaction location meeting the location restriction.

In one embodiment, the transaction risk configuration data may identify a law, a regulation, and/or a policy that specifies an age requirement for transactions conducted at the merchant URL, and the customer profile identifies a customer age, and the transaction may be determined to be a risky transaction in response to the customer age being below the age requirement.

In one embodiment, the transaction scoring service computer program may include an inline appliance in a network comprising the electronic device, the transaction scoring service computer program, and the merchant backend.

In one embodiment, the method may further include communicating, by the transaction scoring service computer program, an out of band authentication message to a second electronic device for the customer.

### BRIEF DESCRIPTION OF THE DRAWINGS

In order to facilitate a fuller understanding of the present invention, reference is now made to the attached drawings in which:

FIG. 1 discloses system for assigning a transaction risk score according to one embodiment;

FIG. 2 discloses a method for assessing transaction risk for a transaction conducted at a merchant according to one embodiment;

FIG. 3 discloses a method for assessing transaction risk for a transaction conducted with a consumer electronic device according to one embodiment; and

FIG. 4 discloses a method for assessing transaction risk according to another embodiment.

### DETAILED DESCRIPTION OF PREFERRED EMBODIMENTS

Embodiments are directed to systems, methods, and devices for assigning a transaction risk score. In embodiments, a transaction risk score may be assigned to transactions to inform consumers—both individuals and business employees—of the potential hazard they risk when transacting. Certain institutions, such as financial institutions that issue credit cards, have a large volume of data that may be used to assess fraud. Examples of such data include transactional data that includes charge backs, claims of fraud, typical shopping behavior, length of relationship with the financial institution, etc. This data may be leveraged to assess the riskiness of transactions and proactively prevent fraud. In embodiments, the data may be used to assign a risk score to devices, merchants, and individuals.

In one embodiment, artificial intelligence and/or machine learning may be used to automate the evaluation of the data and to assess risk.

Embodiments may also assign a device score to transaction devices, such as Internet of Things appliances, such as smart speakers executing a spoken command, refrigerators that identify low inventory and orders on behalf of the owner, printers that re-order ink, etc. While these devices greatly improve convenience and efficiency, certain categories/types/individual of devices may have vulnerabilities that malicious actors can exploit to transact fraudulently. The financial institution may assign a score to a category of devices, a type of device, or a specific/individual device based on observed transaction data.

In embodiments, vulnerability data around each type of device may be incorporated to assist and inform the generation of the device score.

Embodiments may further assign a merchant score. For example, embodiments may evaluate risky transactions and may notify consumers of potential fraud is a well-developed space; however, as eMerchants are able to change their IP addresses and URLs, bad actors can be a moving target. By leveraging financial institutions' databases, merchants may be better evaluated, and an accurate score that indicates the level of risk may be assigned.

In addition, a merchant may be a known security risk. For example, a merchant may be susceptible to or may have had data breaches. Embodiments may warn consumers of such risky merchants, and may present alternate mechanisms for conducting a transaction with such a risky merchant, such as using a single use payment device, anonymized consumer and/or device information, etc.

In one embodiment, instead of being presented with a risky merchant's webpage, a transaction scoring service may present a warning page to the consumer. In one embodiment, the consumer may be given an option to continue with the transaction after reviewing the warning. In another embodiment, the consumer may be prevented from entering credit card information. In still another embodiment, the consumer's credit card information, device information, etc. may be automatically anonymized. For example, a single use payment device may be generated for the consumer, and the consumer's contact information, other than mailing address, may be anonymized.

Consumers are generally required to provide an address at two points in most online transaction: (1) to authenticate the method of payment and (2) to provide a physical location for delivery. To authenticate for transaction approval, the consumer's financial institution may independently authenticate the consumer and send the transaction approval to the consumer. If the merchant lacks the infrastructure to receive the authenticated transaction from the financial institution, the financial institution may generate a pseudonymous address not associated with any physical location but that is sufficient to authorize the transaction; the financial institution may provide that address information to the consumer to input into the appropriate fields. If the consumer is using a privacy appliance inline with the network architecture, the pseudonymous address may be auto populated into the appropriate fields.

To protect consumers' physical address while enabling delivery of the purchased item, the financial institution may establish (by itself or in partnership) a physical receiving location (e.g., a post office box, a locker, a third-party location etc.). Along with the information to approve the transaction, the financial institution may transmit to the merchant a unique identifier along with the receiving location address such that the package can be received, sorted, and routed to the consumer's physical address. Or the financial institution may send the receiving center location address and unique identifier to the consumer, which may be input into the appropriate fields.

In another embodiment, the consumer may retrieve the package from the physical location without having it re-routed to the consumer's home address. Thus, the anonymized consumer will remain anonymous to the merchant.

If the consumer is using the inline privacy appliance, the pseudonymous address may be auto populated into the appropriate fields.

In another embodiment, individual consumers may be provided with an individual score for their behaviors. For example, individual consumers may—knowingly or unknowingly—engage in risky behavior that may increase their risk of exposure to fraud. A financial institution, particularly one with knowledge of deviations in a consumer's normal digital activity, may assign a risk score to that activity, including transactional. For example, the financial institution may have data on what the consumer's “normal” activity looks like, based on, for example, a location of the consumer, a location of the merchant, transaction amounts, devices, etc. A financial institution, particularly one with knowledge of deviations in a consumer's normal digital activity, may assign a risk score to that activity, including transactions.

Additionally, while most fraud detection is targeted at protecting the consumer from fraud, such a risk score may be assigned to enable a financial institution to protect a merchant from being defrauded by a risky consumer and/or a risky electronic device. In embodiments, merchants may define risk in any suitable manner, including risks associated with conducting transactions that may not be fraudulent. For example, a merchant may define risk as a risk of making an illegal or authorized sale (e.g., selling alcohol to a minor), completing a sale originating from a location outside of the consumer's location (e.g., a location that is registered with the consumer's financial institution), etc. A risk score may be returned to the merchant, and the merchant may determine how to proceed. Embodiments may apply merchant-defined rules to take an action on a transaction that has a risk score above a risk threshold. Multiple tiers of risk thresholds may be provided, with each risk threshold requiring additional authorization or verification before the transaction can be completed.

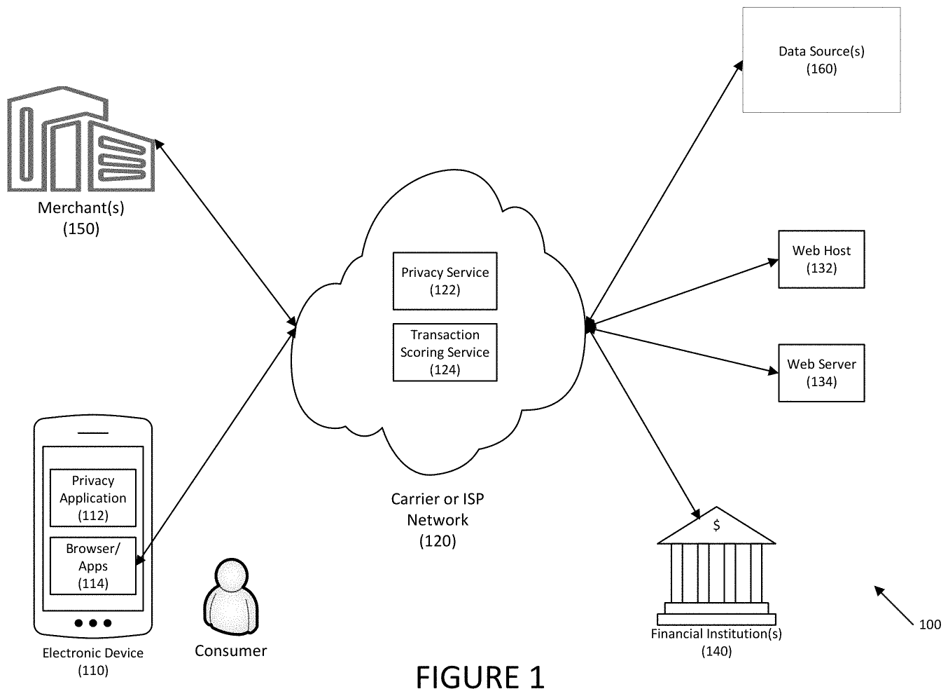

Referring to FIG. 1, a system for assigning a transaction risk score is disclosed according to an embodiment. System 100 may include a consumer, which may be an individual, a business, etc. that may conduct an online transaction using, for example, electronic device 110. Electronic device 110 may be any suitable electronic device, including smart phones, smart appliances, computers (e.g., desktop, notebook, tablet, etc.), Internet of Things (IoT) appliances, kiosks, point of sale devices, etc., and may execute privacy application 112 and browser or applications 114. Electronic device 110 may interface with carrier or ISP network 120, which may include privacy service 122 and transaction scoring service 124. Privacy service 122 may provide services to anonymize the consumer to, for example, web host 132, web server 134, and merchant 150. Examples of such privacy services are disclosed in U.S. patent application Ser. Nos. 16/890,991; 16/598,734; 62/856,491; 62/874,240; and 62/941,247. The disclosures of each of these patent applications is hereby incorporated, by reference, in its entirety.

Transaction scoring service 124 may be a computer program that may assess a risk associated with a transaction being conducted on electronic device 110, with web host 132 or web server 134, or with merchant 150. In one embodiment, transaction scoring service 124 may receive transaction data from one or more financial institutions 140 including, for example, information on disputed transactions from consumers and/or merchants 150. Other data may include unusual transaction activity involving an electronic device (e.g., a high velocity of transactions, fraudulent transaction patterns, etc.).

In one embodiment, data may also be received from merchant 150, web host 132, web server 134, etc.

Transaction scoring service 124 may further receive data from one or more data sources 160, such as data on data breaches associated with merchant 150, attacks on merchant 150, web host 132, and/or web server 134, etc. It may further receive network data and may assess anomalies in network data for potential issues. For example, if there is an unusually high amount of network traffic at merchant 150, it may assess a transaction with merchant 150 as risky.

In embodiments, browsing data may be received from one or more electronic device 110 that is associated with, or registered to, the consumer. For example, the browsing history on electronic device 110 may explain a sudden unexpected purchase (e.g., a large jewelry purchase from an out-of-state merchant) by providing information that the consumer had been shopping online for jewelry for a few days. Browsing information may be captured by a network appliance, by the application, etc.

In one embodiment, transaction scoring service 124 may be provided as a service to a plurality of financial institutions 140, merchants 150, consumers, etc.

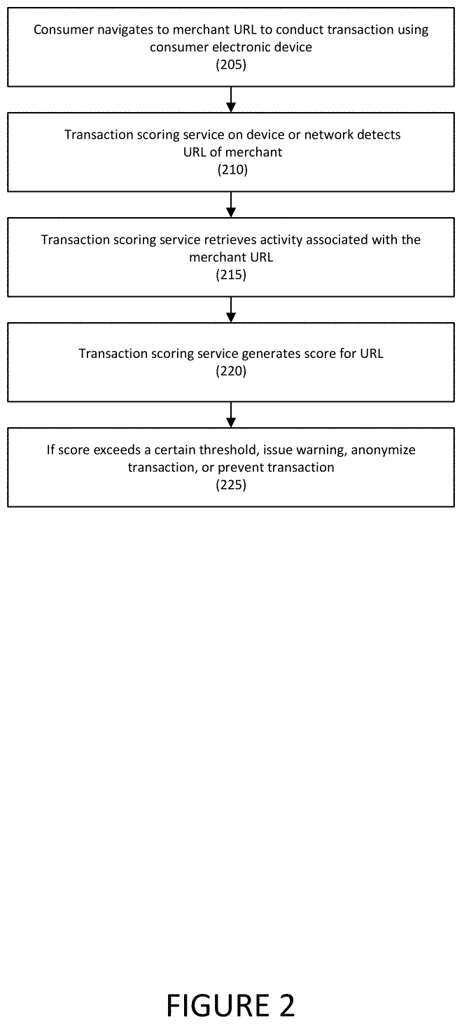

Referring to FIG. 2, a method for assessing transaction risk for a transaction conducted at a merchant is provided according to an embodiment.

In step 205, a consumer may navigate to a merchant URL to conduct a transaction. The transaction may be conducted using a consumer electronic device, such as a computer, a smart phone, an IoT device, etc.

In step 210, a transaction scoring service may detect the merchant URL. For example, the transaction scoring service may receive the merchant URL from an inline device, may receive it from an application executed on the consumer electronic device, etc.

The transaction scoring service may be run as an application on the consumer electronic device, as an inline appliance in the network, etc.

In step 215, the transaction scoring service may retrieve activity associated with the merchant URL, such as fraudulent, disputed, or unusual activity for the merchant URL. For example, transaction scoring service may retrieve transactions for the device from one or more financial institution, from one or more merchant, etc. to identify such fraudulent, disputed, or unusual activity. In one embodiment, the number of such transactions compared to URLs for other merchants, the velocity of such transactions, etc. may be considered in assessing risk.

In embodiments, the transaction scoring service may retrieve network activity data associated with the merchant URL, and may identity any anomalous activity that may be indicative of a risk. For example, if there is an unusual amount of network activity associated with the merchant URL, the transaction scoring service may identify that as risky.

In embodiments, the transaction scoring service may retrieve other data, such as data identifying merchants with data breaches, compromised websites, etc., from third party databases to assess risk.

In step 220, the transaction scoring service may generate a risk score for the merchant URL and/or the consumer device. In one embodiment, the factors that are used to generate the scoring may be weighted based on a confidence level that the factors are indicative of a fraudulent transaction. For example, the presence and/or a number of fraudulent or disputed transactions for the merchant URL versus the total number of transactions at the merchant URL, the presence of anomalous network activity, a history of a data breach, etc. may be given weightings and aggregated to determine a risk score. The weightings may be configurable and may be set by the consumer, or the weightings may be set using machine learning based on historical data.

In step 225, if the score generated by the transaction scoring service exceeds a threshold, the transaction scoring service may generate and present a warning to the consumer. For example, a warning message that identifies the merchant as having a high-risk score may be presented to the consumer via the consumer's electronic device. The consumer may be given an option to proceed, to proceed with safeguards, or to not proceed.

If the consumer decides to proceed with safeguards, the transaction scoring service may anonymize the consumer's information so that consumer information (e.g., contact information) is not provided to the merchant. For example, the transaction scoring service may provide an alternate identity for the consumer, an alternate address, an alternate phone number, an alternate email address, etc. to the merchant. In addition, the transaction scoring service may request the generation of a temporary payment instrument (e.g., a single use account number) for the transaction and this temporary payment instrument may be provided to the merchant for the transaction.

In another embodiment, if the consumer decides to not proceed with the transaction, the transaction scoring service may prevent the transaction from occurring. The transaction scoring service may further block access to the merchant's URL from the consumer's electronic device, as well as from electronic devices for other consumers.

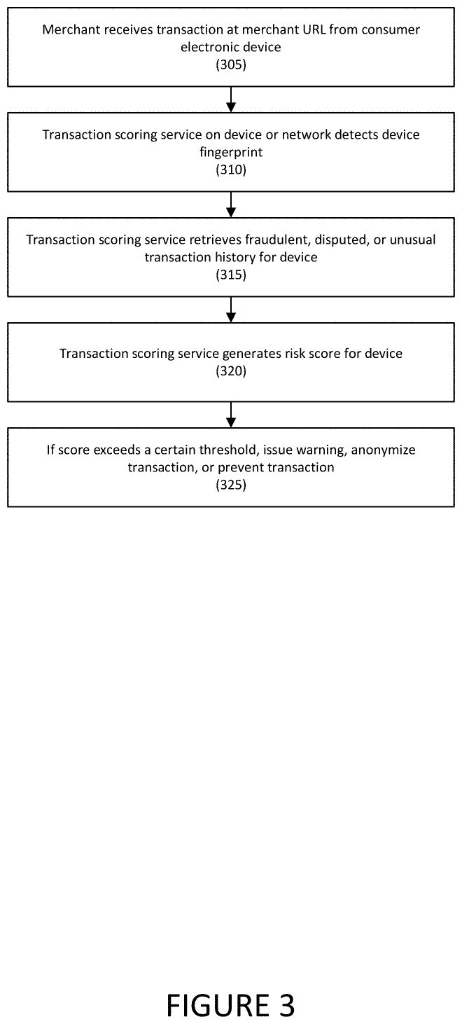

Referring to FIG. 3, a method for assessing transaction risk for a transaction conducted with a consumer electronic device is provided according to an embodiment.

In step 305, a consumer may navigate to a merchant URL to conduct a transaction. The transaction may be conducted using a consumer electronic device (e.g., a computer, smart phone, IoT device, etc.).

In step 310, a transaction scoring service may capture device information, such as a device fingerprint, for the consumer electronic device. The transaction scoring service may be run as an inline appliance in the network, as an application run on the merchant backend, etc.

In one embodiment, a weighting factor may be applied to the device identification based on a confidence level in identifying the consumer electronic device. For example, if the transaction scoring service has a high level of confidence that the consumer electronic device can be identified based on the device fingerprint, then it will be assigned a high weight. If the transaction scoring service has a low level of confidence in the device identification based on the device fingerprint, it will be assigned a low weight.

In step 315, the transaction scoring service may retrieve fraudulent, disputed, or unusual activity involving the consumer electronic device. For example, transaction scoring service may retrieve transactions for the consumer electronic device from one or more financial institution, from one or more merchant, etc. to identify such fraudulent, disputed, or unusual activity.

In embodiments, the transaction scoring service may retrieve network data associated with the consumer electronic device, and may identity any anomalous activity that may be indicative of a risk. For example, if there is an unusual amount of network activity associated with the consumer electronic device, the transaction scoring service may identify the consumer electronic device as risky. As another example, if there is an unusual number of transactions from the consumer electronic device, the transaction scoring service may identify the consumer electronic device as risky.

Other considerations, such as at consumer electronic device being jailbroken, being reported as lost or stolen, being located outside the country, etc., may be considered as is necessary and/or desired.

In one embodiment, the browsing history for the consumer device and any other associated consumer devices (e.g., all devices that may be registered to the consumer based on the identification of the consumer device) may be retrieved in order to identify browsing trends that may be indicative of the propriety of a transaction.

In step 320, the transaction scoring service may generate a score for the consumer device. In one embodiment, the factors that are used to generate the scoring may be weighted based on a confidence level that the factors are indicative of a risky transaction.

In one embodiment, machine learning based on historical transactions may be used to determine the weightings to give the different factors.

In step 325, if the risk score generated by the transaction scoring service exceeds a threshold, a warning may be presented to the merchant. In one embodiment, the merchant may be given the option to decline to conduct the transaction.

If the merchant receives a transaction score for the consumer device indicating a high risk of fraud, the merchant may be warned of the potential fraud. Other authentication options for authenticating the consumer, such as out-of-band authentication using a one-time passcode, the use of out-of-wallet questions, etc. may be used to authenticate the consumer as is necessary and/or desired. In one embodiment, the out-of-bound message may be sent to an alternate device.

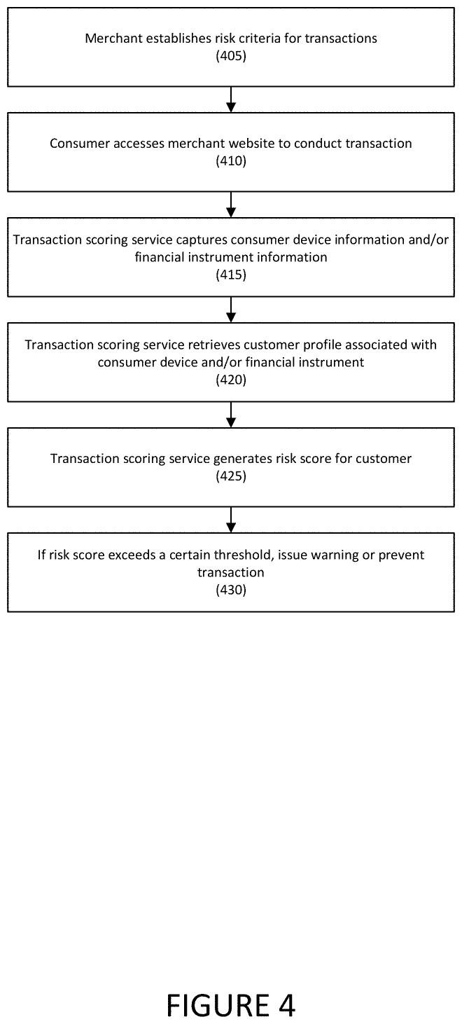

Referring to FIG. 4, a method for assessing transaction risk is provided according to another embodiment. In one embodiment, the transaction risk may be defined by the merchant based on what the merchant considers to be a risky transaction. The risk may not be associated with fraud, but instead on the identity of the consumer with which the merchant is transacting.

In step 405, a merchant may establish risk criteria for transactions it may conduct with consumers. The risk criteria may be based on a type of product that the merchant may be selling (e.g., alcohol), a location of the merchant and potential buyer (e.g., outside of the country), location-specific rules (e.g., state-specific or country-specific restrictions, blackout restrictions, etc.).

In step 410, a consumer may access the merchant's website to conduct a transaction. In one embodiment, the consumer may access the merchant's website using a consumer electronic device. In addition, the consumer may present a financial instrument for payment.

In step 415, a transaction scoring service may capture device information, such as a device fingerprint, for the consumer electronic device. The transaction scoring service may be run as an inline appliance in the network, as an application run on the merchant backend, etc.

Instead of capturing device information, or in addition to capturing device information, the transaction scoring service may capture financial instrument information for the financial instrument that was presented by the consumer.

In step 420, the transaction scoring service may retrieve a customer profile associated with the consumer device and/or the financial instrument. In one embodiment, the transaction scoring service may contact an issuer for the financial instrument for consumer information. For example, the transaction scoring service may query the issuer for certain information, such as if the consumer associated with the financial instrument is over a certain age, is registered to be in a certain location, etc.

In embodiments, the issuing financial institution may report on how long the consumer has been a customer of the financial institution, as longer relationships with good history are, in general, less likely be fraudulent. The device identifier, mobile phone number, etc. may be passed to the financial institution to determine whether the electronic device is a known device or an unknown device.

In one embodiment, the transaction scoring service may a network provider (e.g., a wireless provider) with which the consumer electronic device is registered for similar information. For example, a wireless provider may validate the electronic device identifier, SIM card identifier, electronic serial number, etc. and may return similar feedback regarding the status of the electronic device.

In step 425, the transaction scoring service may generate a risk score for the merchant. In one embodiment, the risk score may be weighted based on the risk criteria provided by the merchant, and may use weightings from the risk criteria. The weightings may be adjusted, for example, based on machine learning.

In step 430, the transaction scoring service may compare the risk score to one or more thresholds for the merchant, and may take an appropriate action should the risk score exceed one or more threshold. For example, the transaction scoring service may recommend that the merchant reject the transaction, may request out-of-band verification, etc. As another example, the merchant may require confirmed payment, such as a money order, bank check, electronic funds transfer, etc.) before the product is shipped.

In embodiments, a business may be provided with a risk score for commercial cards used by its employees. For example, businesses often employ commercial credit cards that employees may use when traveling or conducting official company business. These transactions are typically submitted for reimbursement via an expense report or travel claim. In embodiments, after receiving the reimbursement request, a financial institution may evaluate and assign a risk score to each transaction as discussed above, and may present a summary to the business or manager to automate approval, or may flag certain potential fraudulent transactions for additional review.

Because purchase rules may not account for every place a purchase may be made, the score may provide approving managers with deeper insight into the transaction via the risk score that may be based on past transactions, disputes, website age and other variables.

Although multiple embodiments have been disclosed, it should be recognized that these embodiments are not mutually exclusive and features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for generating a transaction risk score, comprising:
receiving, by a transaction scoring service computer program and from an electronic device, a merchant URL that is being accessed by an application or a browser executed on the electronic device;
retrieving, by the transaction scoring service computer program, a plurality of transactions involving the merchant URL;
generating, by the transaction scoring service computer program, a risk score for the merchant URL based on the plurality of transactions;
generating, by the transaction scoring service computer program, a warning in response to the risk score exceeding a predetermined threshold; and
communicating, by the transaction scoring service computer program, the warning to the application or the browser.

2. The method of claim 1, wherein the transaction scoring service computer program comprises an inline appliance in a network comprising the electronic device, the transaction scoring service computer program, and a merchant backend hosting the merchant URL.

3. The method of claim 1, wherein the electronic device comprises a computer, a smart phone, or an Internet of Things appliance.

4. The method of claim 1, wherein the plurality of transactions involving the merchant URL are received from a financial institution.

5. The method of claim 1, wherein the plurality of transactions involving the merchant URL are classified as fraudulent transactions, non-fraudulent transactions, or disputed tractions.

6. The method of claim 1, further comprising:
retrieving, by the transaction scoring service computer program, network activity data for the merchant URL;
wherein the transaction scoring service computer program further generates the risk score for the merchant URL based on the network activity data.

7. The method of claim 1, further comprising:
retrieving, by the transaction scoring service computer program, data breach data the merchant URL;
wherein the transaction scoring service computer program further generates the risk score for the merchant URL based on the data breach data.

8. A method for generating a transaction risk score, comprising:
receiving, by a transaction scoring service computer program and from a merchant backend, an identification of an electronic device executing an application or a browser and accessing a merchant URL;
retrieving, by the transaction scoring service computer program, a plurality of transactions involving the electronic device;
generating, by the transaction scoring service computer program, a risk score for the electronic device based on the plurality of transactions;
generating, by the transaction scoring service computer program, a warning in response to the risk score exceeding a predetermined threshold; and
communicating, by the transaction scoring service computer program, the warning to the merchant backend.

9. The method of claim 8, wherein the transaction scoring service computer program comprises an inline appliance in a network comprising the electronic device, the transaction scoring service computer program, and the merchant backend.

10. The method of claim 8, wherein the electronic device comprises a computer, a smart phone, or an Internet of Things appliance.

11. The method of claim 8, wherein the plurality of transactions involving the electronic device are received from a financial institution.

12. The method of claim 8, wherein the plurality of transactions involving the electronic device are classified as fraudulent transactions, non-fraudulent transactions, or disputed tractions.

13. The method of claim 8, further comprising:
determining, by the transaction scoring service computer program, a confidence level in the identification of the electronic device;
wherein the risk score for the electronic device is further based on the confidence level.

14. The method of claim 8, further comprising:
retrieving, by the transaction scoring service computer program, network activity data for the electronic device;
wherein the transaction scoring service program further generates the risk score for the electronic device based on the network activity data.

15. A method for generating a transaction risk score, comprising:
receiving, by a transaction scoring service computer program and from a merchant backend, transaction risk configuration data that identifies risky transactions for transactions conducted at the merchant backend;
receiving, by the transaction scoring service computer program and from the merchant backend, transaction information comprising electronic device transaction information for an electronic device conducting a transaction at a merchant URL and/or customer information a customer conducting the transaction at the merchant URL;
retrieving, by the transaction scoring service computer program, a customer profile associated with the electronic device and/or the customer information;
generating, by the transaction scoring service computer program, a transaction risk for the electronic device based on the customer profile and the customer profile;
determining, by the transaction scoring service computer program and based on a comparison of the transaction risk and the transaction risk configuration data, that the transaction is a risky transaction;
generating, by the transaction scoring service computer program, a warning for the risky transaction; and
communicating, by the transaction scoring service computer program, the warning to the merchant backend.

16. The method of claim 15, wherein the transaction risk configuration data identifies a location-based risk, and the customer profile identifies a registered customer location; and
wherein the transaction is determined to be a risky transaction in response to the registered customer location differing from a transaction location.

17. The method of claim 15, wherein the transaction risk configuration data identifies a location restriction, and the transaction information comprises a transaction location for the transaction, wherein the transaction is determined to be a risky transaction in response to the transaction location meeting the location restriction.

18. The method of claim 15, wherein the transaction risk configuration data identifies a law, a regulation, and/or a policy that specifies an age requirement for transactions conducted at the merchant URL, and the customer profile identifies a customer age, and wherein the transaction is determined to be a risky transaction in response to the customer age being below the age requirement.

19. The method of claim 15, wherein the transaction scoring service computer program comprises an inline appliance in a network comprising the electronic device, the transaction scoring service computer program, and the merchant backend.

20. The method of claim 15, further comprising:
communicating, by the transaction scoring service computer program, an out of band authentication message to a second electronic device for the customer.
